(19) United States
(12) Patent Application Publication
(10) Pub. No.: US 2023/0392632 A1
(43) Pub. Date: Dec. 7, 2023

(54) KERF-MOUNTED MITER BRACKET ASSEMBLY

(71) Applicant: Knoll, Inc., Zeeland, MI (US)

(72) Inventors: John G. Stark, Oakville (CA); Andre Witte, Woodbridge (CA)

(21) Appl. No.: 18/326,936

(22) Filed: May 31, 2023

Related U.S. Application Data
(60) Provisional application No. 63/347,280, filed on May 31, 2022.

(51) Int. Cl. F16B 12/50

(52) U.S. Cl. CPC F16B 12/50; F16B 2012/505

(57) ABSTRACT

A bracket assembly is configured to join a first board and a second board. The bracket assembly includes an angled bracket having a first segment configured to be inserted into the first board and a second segment forming a nonzero angle with the first segment and configured to be inserted into the second board. The bracket assembly also includes a clamping bracket configured to press against a first kerf on the first board and a second kerf on the second board, and a fastener coupled to the angled bracket and extending through the clamping bracket.

### CROSS-REFERENCE TO RELATED APPLICATIONS

This application claims priority to U.S. Provisional Application No. 63/347,280, filed May 31, 2022, the entire contents of which are incorporated by reference herein.

### FIELD OF INVENTION

The present invention relates to bracket assemblies configured to be mounted in kerfs adjacent miter joints of two boards and, more particularly, to bracket assemblies configured to be mounted in kerfs adjacent miter joints of desks or tables.

### SUMMARY

In one embodiment, a bracket assembly is configured to join a first board and a second board. The bracket assembly includes an angled bracket having a first segment configured to be inserted into the first board and a second segment forming a nonzero angle with the first segment and configured to be inserted into the second board. The bracket assembly also includes a clamping bracket configured to press against a first kerf on the first board and a second kerf on the second board, and a fastener coupled to the angled bracket and extending through the clamping bracket.

In another embodiment, a furniture article includes a first board having a first slot and a first kerf, a second board having a second slot and a second kerf, and an angled bracket having a first segment and a second segment extending from the first segment. The first segment is positioned into the first slot, and the second segment is positioned in the second slot. The furniture article also includes a clamping bracket pressing against the first kerf and the second kerf such that the first board and the second board are drawn together, and a fastener extending through the angled bracket and the clamping bracket.

In another embodiment, a method for assembling a furniture article including a first board and second board includes inserting a first segment of an angled bracket into the first board, and inserting a second segment of the angled bracket into the second board. The second segment forms a nonzero angle with the first segment. The method also includes positioning a clamping bracket against a first kerf on the first board and a second kerf of the second board, coupling a fastener to the angled bracket and the clamping bracket, and tightening the fastener such that the clamping bracket presses against the first kerf and the second kerf to draw the first board and the second board together.

Other aspects of the invention will become apparent by consideration of the detailed description and accompanying drawings.

### BRIEF DESCRIPTION OF THE DRAWINGS

FIG. 1 is a perspective view of a miter joint system according to some embodiments.

FIG. 2 is a perspective view of boards of the miter joint system shown in FIG. 1.

FIG. 3 is a perspective view of one of the boards of the miter joint system shown in FIG. 1.

FIG. 4 is an enlarged perspective view of the boards of the miter joint system shown in FIG. 1.

FIG. 5 is an enlarged perspective view of one of the boards of the miter joint system shown in FIG. 1.

FIG. 6 is an enlarged perspective view of boards of the miter joint system shown in FIG. 1 arranged parallel to one another.

FIG. 7 is an enlarged perspective view of boards of the miter joint system of FIG. 1 including kerfs.

FIG. 8 is an enlarged perspective view of a portion of the miter joint system shown in FIG. 1.

FIG. 9 is a perspective view of a bracket subassembly of the miter joint system shown in FIG. 8.

FIG. 10 is an exploded view of the bracket subassembly shown in FIG. 9.

FIG. 11 is a perspective view of an angled bracket of the bracket subassembly shown in FIG. 10.

FIG. 12 is a first perspective view of a first clamping bracket of the bracket subassembly shown in FIG. 9.

FIG. 13 is a second perspective view of the first clamping bracket shown in FIG. 12.

FIG. 14 is a first perspective view of a second clamping bracket of the miter joint system shown in FIG. 1.

FIG. 15 is a second perspective view of the second clamping bracket shown in FIG. 14.

FIG. 16 is a first enlarged cross-section view of the miter joint system with the bracket subassembly shown in FIG. 9.

FIG. 17 is a second enlarged cross-section view of the miter joint system with the bracket subassembly shown in FIG. 9.

FIG. 18 is an exploded view of a bracket subassembly of a miter joint system according to another embodiment.

FIG. 19 is a perspective view of an angled bracket of the bracket subassembly shown in FIG. 18.

FIG. 20 is a first enlarged cross-section view of a miter joint system with the bracket subassembly shown in FIG. 18.

FIG. 21 is a second enlarged cross-section view of the miter joint system with the bracket subassembly shown in FIG. 18.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

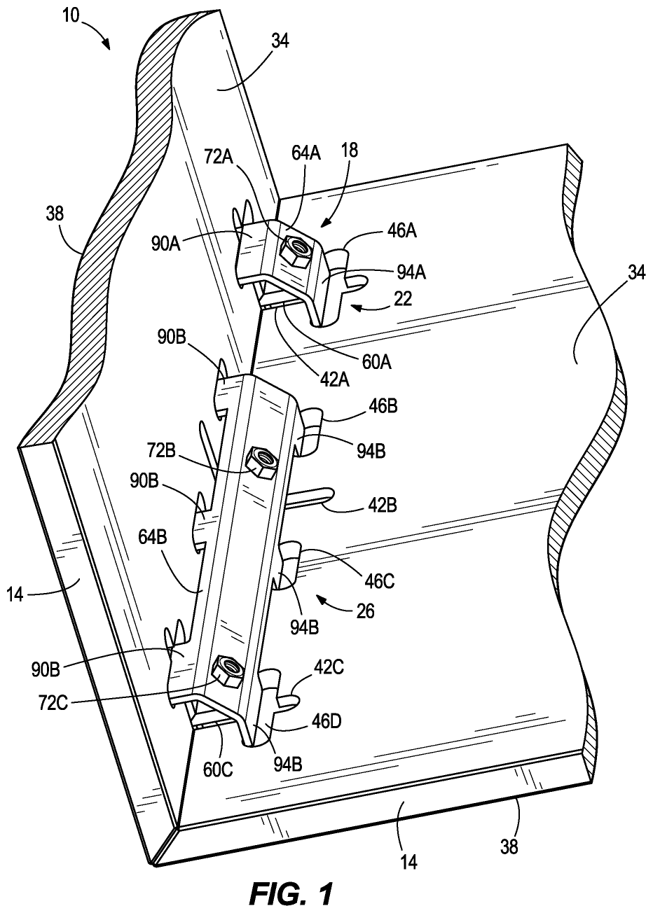

FIG. 1 illustrates a miter joint system 10. The miter joint system 10 may form a connection in a furniture article, such as a table, a desk, a chair, a bed, a frame, a countertop, a cabinet, and the like. In the illustrated embodiment, the miter joint system 10 is configured for a desk with a waterfall-style leg. The miter joint system 10 includes a pair of boards 14, or panels, and a bracket assembly 18 joining the boards 14. The illustrated bracket assembly 18 includes a first bracket subassembly 22 and a second bracket subassembly 26. In other embodiments, the bracket assembly 18 may include only one of the first bracket subassembly 22 or the second bracket subassembly 26, or a single elongated bracket assembly. In other embodiments, the bracket assembly 18 may include a plurality of first bracket subassemblies 22 or second bracket subassemblies 26. As illustrated, the boards 14 are beveled such that they form a miter joint with each other. When the boards 14 are joined, the boards 14 are perpendicular to each other. In other embodiments, the boards 14 may be at an obtuse angle to each other. In other embodiments, the boards 14 may be at an acute angle to each other.

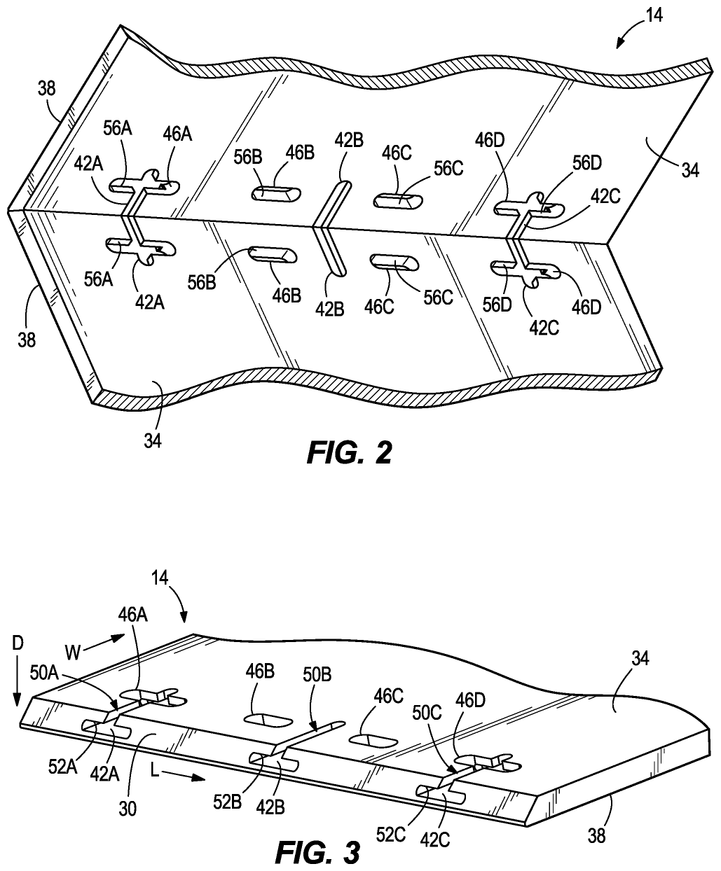

FIGS. 2 and 3 illustrate the boards 14 of the miter joint system 10. In the illustrated embodiment, the boards 14 are formed from wood. In other embodiments, the boards 14 may be formed from other materials, such as a laminated, plastic, or composite material. Each of the boards 14 is beveled to form a miter surface 30. When the boards 14 are coupled together, the miter surfaces 30 abut each other. The boards 14 are mirror symmetrical, so for sake of brevity, only one of the boards 14 will be described in detail. The board 14 includes an inner surface 34 and an outer surface 38 opposite the inner surface 34. The inner surface 34 generally faces inwardly relative to the furniture article, while the outer surface 38 generally faces outwardly and is a visible exterior surface of the furniture article. The inner surface 34 and the outer surface 38 are planar. In other embodiments, the inner surface 34 and/or the outer surface 38 may be non-planar and/or may have surface ornamentations. The miter surface 30 extends from the inner surface 34 and the outer surface 38. The miter surface 30 is elongated along a miter length direction L.

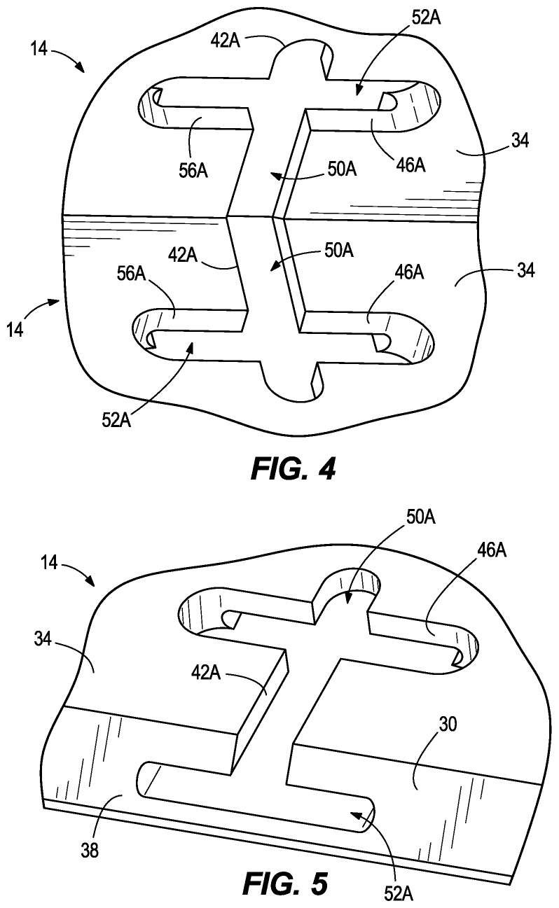

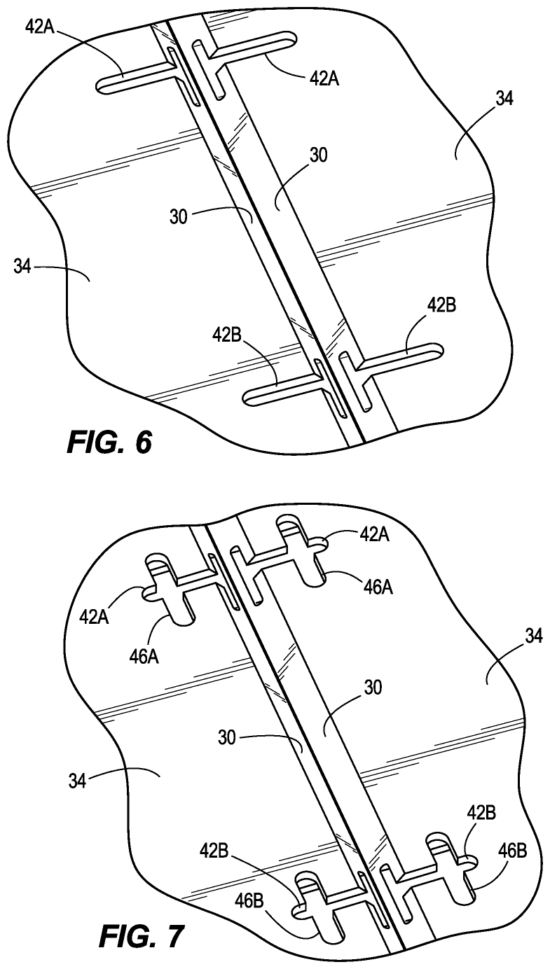

With reference to FIGS. 2-7, the board 14 includes a plurality of slots 42A-C and a plurality of kerfs 46A-D. The slots 42A-C are generally T-shaped and may also be referred to as T-shaped slots. The T-shaped slots 42A-C are spaced from each other. Each of the T-shaped slots 42A-C extends from the miter surface 30 in a miter width direction W which is perpendicular to the miter length direction L. Each of the T-shaped slots 42A-C also extends from the inner planar surface 34 in a miter depth direction D perpendicular to the miter length direction L and the miter width direction W. Each of the T-shaped slots 42A-C has a T-shaped cross-section in a plane perpendicular to the inner surface 34. Each of the T-shaped slots 42A-C has a first portion 50A-C which opens into the inner surface 34 and a second portion 52A-C which opens into the miter surface 30. The first portion 50A-C has a smaller width than the second portion 52A-C.

Each of the kerfs 46A-D extends from the inner surface 34 toward the outer surface 38 in the miter depth direction D. The plurality of kerfs 46A-D are spaced from each other. The kerfs 46A-D are elongated in the miter length direction L. Each of the kerfs 46A-D defines a kerf surface 56A-D adjacent the miter surface 30 and perpendicular to the inner surface 34. As illustrated, the first kerf 46A intersects the first T-shaped slot 42A, and the fourth kerf 46D intersects the third T-shaped slot 42C. The second T-shaped slot 42B is located between and is spaced from the second kerf 46B and the third kerf 46C.

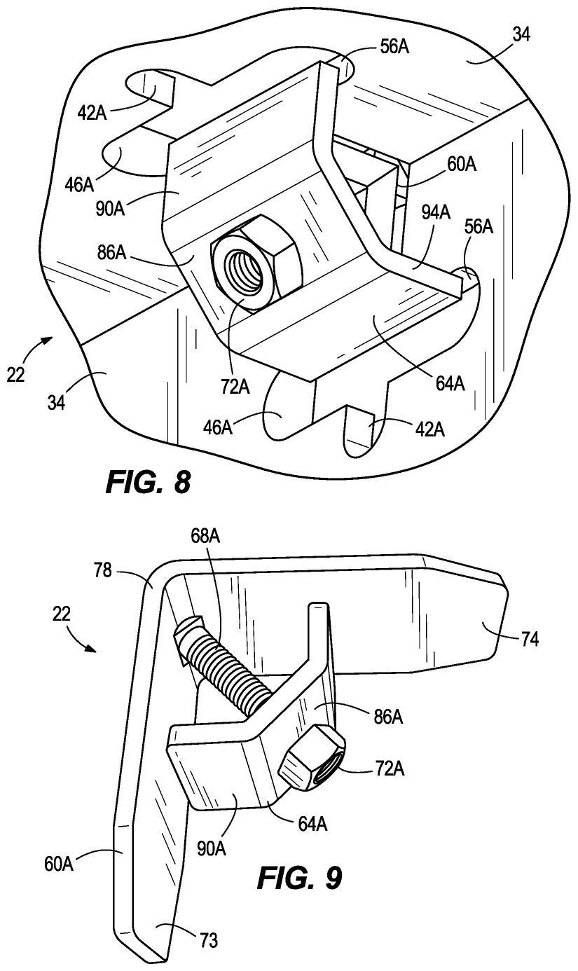

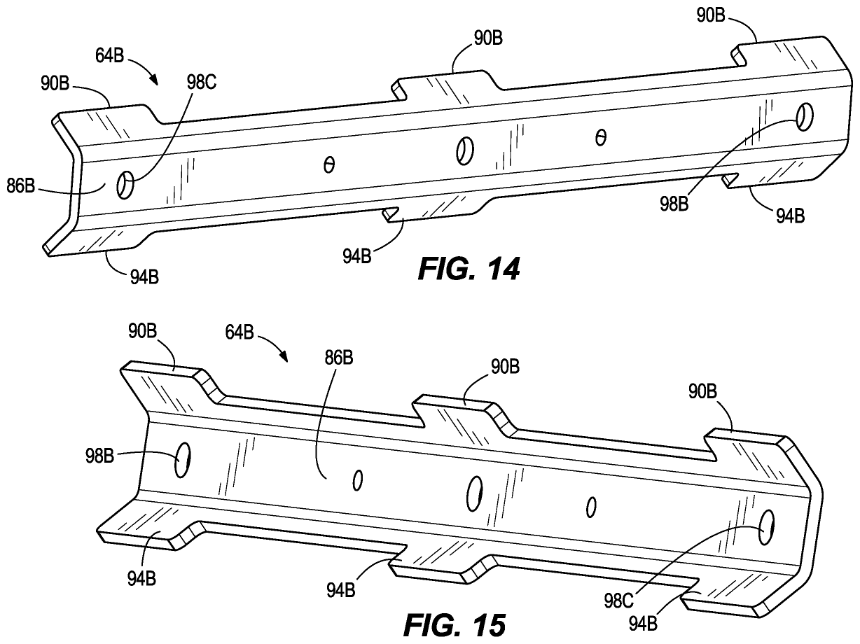

FIGS. 8-10 illustrate the first bracket subassembly 22, which includes a first angled bracket 60A, a first clamping bracket 64A, a first fastener 68A, and a first nut 72A. Although the first bracket subassembly 22 is illustrated with the first clamping bracket 64A, the first bracket subassembly 22 may alternatively include a second clamping bracket 64B (FIGS. 14 and 15) or a different clamping bracket. In the illustrated embodiment, the first fastener 68A is a square head bolt. The first nut 72A is a hex nut with a top distorted thread. The first angled bracket 60A is substantially L-shaped. The clamping bracket 64A is substantially C-shaped. In the illustrated embodiment, the brackets 60A, 64A are formed from stamped sheet-metal. In other embodiments, the brackets 60A, 64A may be formed from casting. In the illustrated embodiment, the brackets 60A, 64A are formed from steel. In other embodiments, the brackets 64A may be formed from other metals, such as zinc or aluminum.

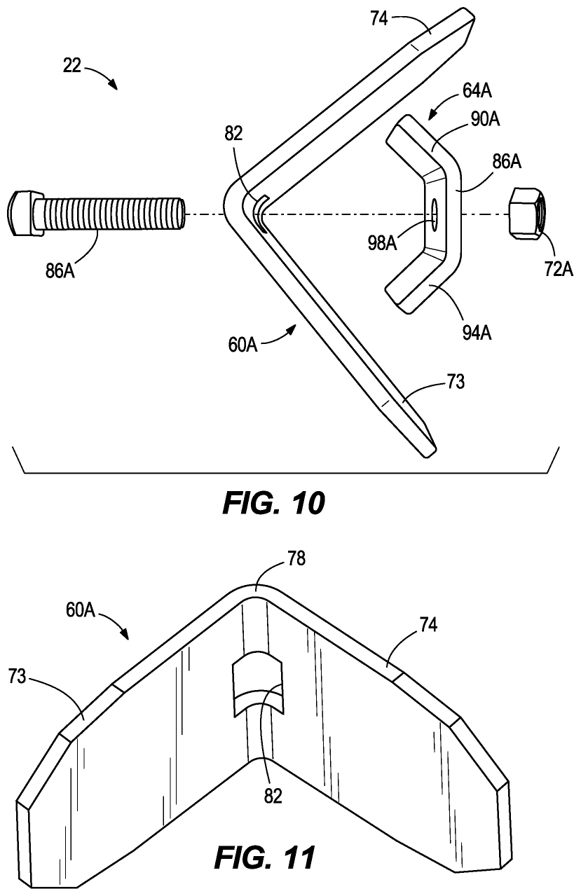

As shown in FIGS. 10 and 11, the first angled bracket 60A includes a first segment 73 and a second segment 74 intersecting with the first segment 73 at a corner 78. The first segment 73 and the second segment 74 are perpendicular to each other. In other embodiments, the first segment 73 and the second segment 74 may be at an oblique angle or nonzero angle to each other, depending on the angle of the miter joint between the boards 14. An opening 82 is formed through the corner 78, the first segment 73, and the second segment 74. The opening 82 is square-shaped. In other embodiments, the opening 82 may have other non-circular shapes (e.g., D-shaped, hexagonal, etc.) to receive a head of the first fastener 68A.

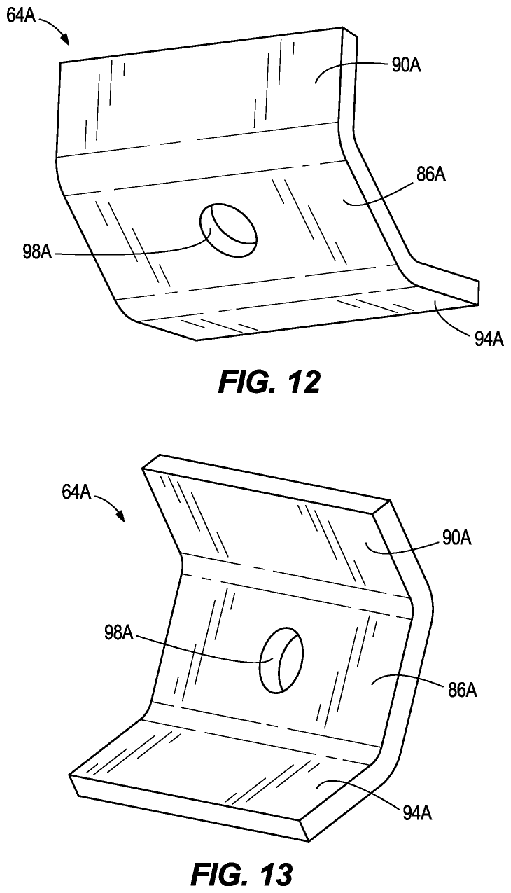

FIGS. 12 and 13 illustrate the first clamping bracket 64A. The first clamping bracket 64A includes a center portion 86A, a first leg 90A extending from the center portion 86A, and a second leg 94A extending from the center portion 86A and opposite from the first leg 90A. The first leg 90A is positioned at an obtuse angle to the center portion 86A. The second leg 94A is positioned at an obtuse angle to the center portion 86A. The second leg 94A is generally perpendicular to the first leg 90A. The first clamping bracket 64A includes a through-hole 98A in the center portion 86A. In the illustrated embodiment, the through-hole 98A is circular. In some embodiments, the through-hole 98A may be threaded or may have other shapes.

FIGS. 14 and 15 illustrate the second clamping bracket 64B. The second clamping bracket 64B is similar to the first clamping bracket 64A and includes a center portion 86B, a plurality of first legs 90B extending from the elongated center portion 86B, and a plurality of second legs 94B extending from the elongated center portion 86B and opposite from the plurality of first legs 90B. The second clamping bracket 64B is different from the first clamping bracket 64A in that the second clamping bracket 64B includes more than two legs and is elongated. Additionally, the second clamping bracket 64B includes a plurality of through-holes 98B, 98C in the center portion 86B. In some embodiments, the through-holes 98B may be threaded. Each of the legs 90A-B of the clamping brackets 64A-B are shaped to fit within a respective kerf 46A-D of one of the boards 14. In the illustrated embodiment, each of the legs 90A-B presses against a kerf surface 56A-C, holding the boards 14 in place.

In the illustrated embodiment, the second clamping bracket 64B is formed from stamped sheet-metal. In other embodiments, the second clamping bracket 64B may be formed from casting. In the illustrated embodiment, the second clamping bracket 64B is formed from steel. In other embodiments, the second clamping bracket 64B may be formed from other metals, such as zinc or aluminum.

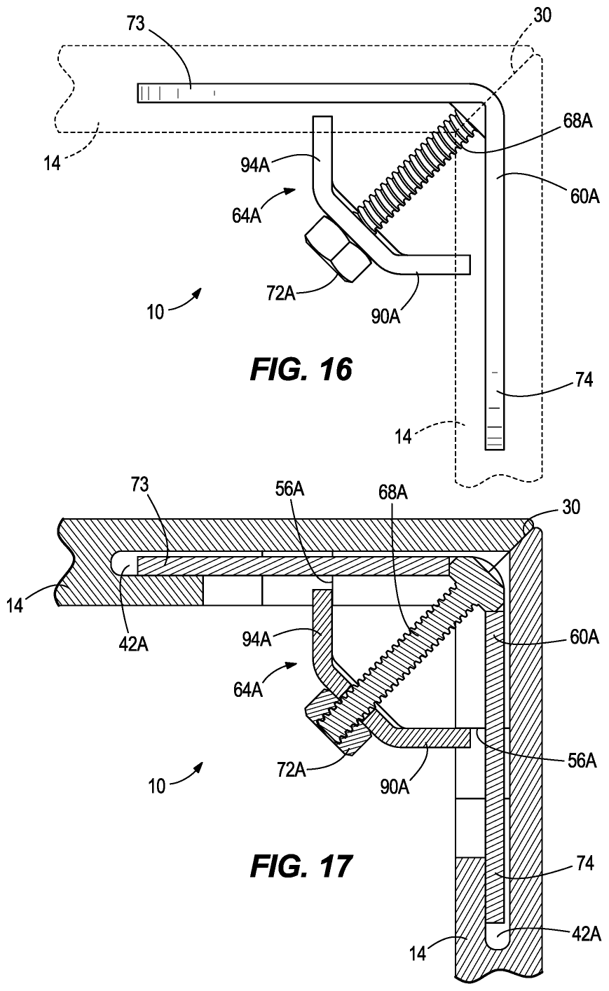

FIGS. 16 and 17 illustrate an exemplary miter joint system 10 using the first bracket subassembly 22 to connect two boards 14. During assembly, the angled bracket 60A is arranged in the first T-shaped slots 42A of the boards 14. Specifically, the first segment 73 extends into one of the boards 14, and the second segment 74 extends into the other one of the boards 14. The boards 14 are positioned such that the miter surfaces 30 lay against each other, forming a cavity surrounding the angled bracket 60A. The boards 14 are also positioned such that the T-shaped slots 42A-C and kerfs 46A-D of one of the boards 14 are aligned with the T-shaped slots 42A-C and kerfs 46A-D of the other one of the boards 14. The kerf surfaces 56A of the boards 14 are perpendicular to each other. The first clamping bracket 64A is positioned against the kerf surfaces 56A. Specifically, the first leg 90A presses against the kerf surface 56A of one of the boards 14, and the second leg 94A presses against the kerf surface 56A of the other one of the boards 14. The first fastener 68A extends through the opening 82 of the first angled bracket the T-shaped slots 42A of the boards 14, and the through-hole 98A of the first clamping bracket 64A. The first nut 72A is threaded and tightened on the first fastener 68A such that the first bracket subassembly 22 and the boards 14 are held together. As the first nut 72A is tightened, the first clamping bracket 64A draws and holds the boards 14 together. The first nut 72A holds the first clamping bracket 64A against the kerf surfaces 56A.

Other embodiments of the bracket subassembly may incorporate a different combination of components including another clamping bracket or angled bracket. For example, the second bracket subassembly 26 shown in FIG. 1 includes a second angled bracket, a third angled bracket 60C, the second clamping bracket 64B, a second fastener, a third fastener, a second nut 72B, and a third nut 72C. The second angled bracket and the third angled bracket are the same as the first angled bracket 60A. The second fastener and the third fastener are the same as the first fastener 68A. The second nut 72B and the third nut 72C are the same as the first nut 72A.

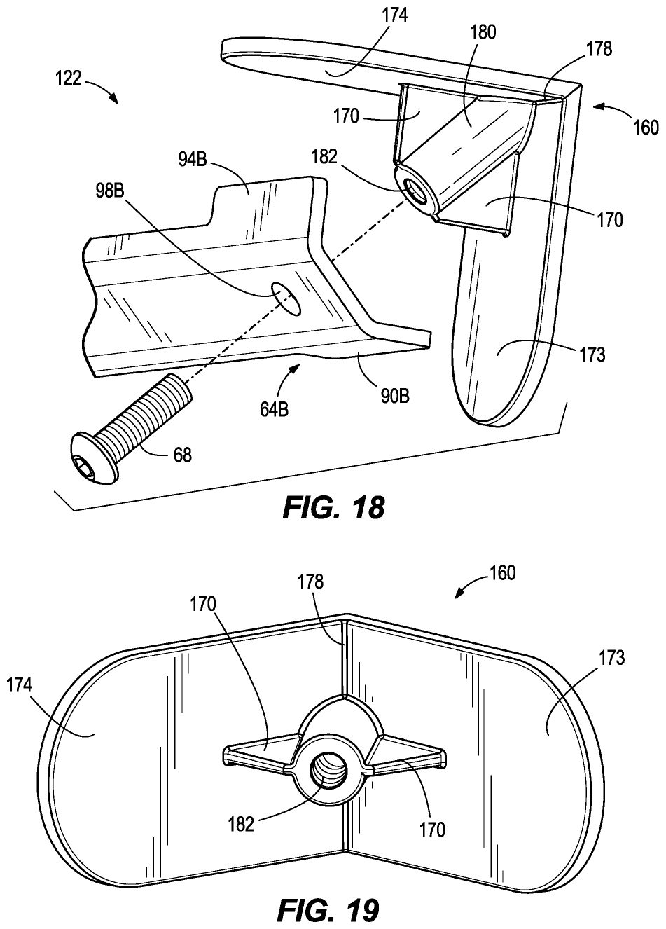

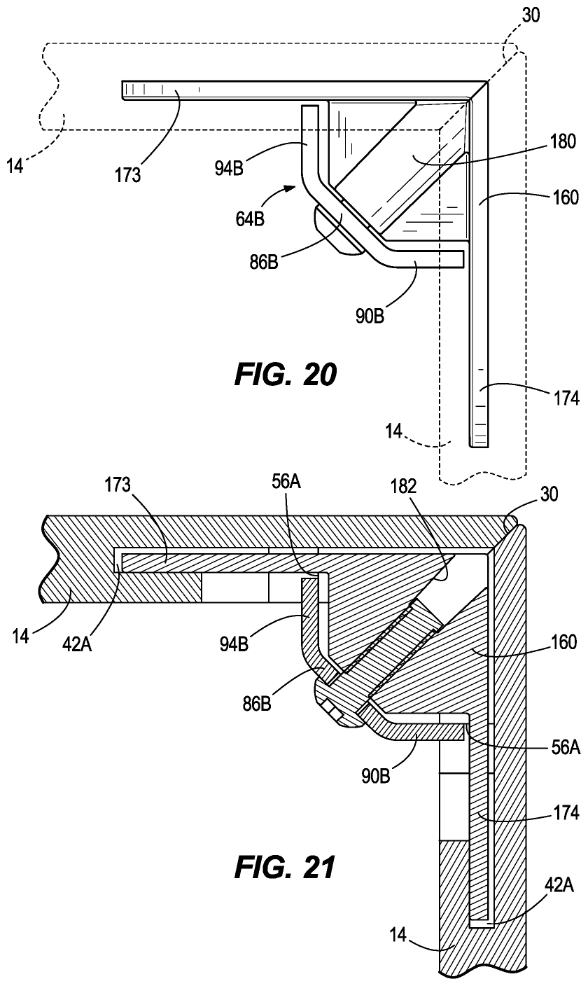

FIGS. 18 and 19 illustrate another bracket subassembly 122. The bracket subassembly 122 may also be referred to as a third bracket subassembly 122. The third bracket subassembly 122 may be used in place of or in addition to the first bracket subassembly 22 or the second bracket subassembly 26. The illustrated third bracket subassembly 122 includes another angled bracket 160, the second clamping bracket 64B, and a fastener 168. Although the bracket subassembly 122 is illustrated with the second clamping bracket 64B, the bracket subassembly 122 may alternatively include the first clamping bracket 64A (FIG. 9) or a different clamping bracket. The second angled bracket 164 has a first segment 173 and a second segment 174 intersecting the first segment 173 at a corner 178. The first segment 173 and the second segment 174 are perpendicular to each other. In other embodiments, the first segment 173 and the second segment 174 may be at an oblique angle or nonzero angle to each other, depending on the angle of the miter joint between the boards 14. The angled bracket 160 further includes a boss 180 extending from the corner 178. The boss 180 extends inwardly from the corner 178, toward the second clamping bracket 64B. The illustrated boss 180 has a cylindrical shape. The boss 180 is supported by two fins 170 extending to the first segment 173 and the second segment 174, respectively. In other embodiments, the boss 180 may have a different shape and/or may be supported by a different number of fins 170. The boss 180 also defines a bore 182 that is configured to receiver the fastener 168. The illustrated bore 182 is a blind bore and includes internal threads to threadably couple the fastener 168 to the angled bracket 160.

FIGS. 21 and 22 illustrate an exemplary miter joint system 10 using the third bracket subassembly 122 to connect two boards 14. During assembly, the angled bracket 160 is arranged in the first T-shaped slots 42A of the boards 14. Specifically, the first segment 173 extends into one of the boards 14, and the second segment 174 extends into the other one of the boards 14. The boards 14 are positioned such that the miter surfaces 30 lay against each other, forming a cavity surrounding the angled bracket 160. The boards 14 are also positioned such that the T-shaped slots 42A-C and kerfs 46A-D of one of the boards 14 are aligned with the T-shaped slots 42A-C and kerfs 46A-D of the other one of the boards 14. The kerf surfaces 56A of the boards 14 are perpendicular to each other. The second clamping bracket 64B is positioned against the kerf surfaces 56A. Specifically, the first leg 90B presses against the kerf surface 56A of one of the boards 14, and the second leg 94B presses against the kerf surface 56A of the other one of the boards 14. The fastener 168 extends through the through-hole 98B of the second clamping bracket 64B and into the bore 182 of the angled bracket 160. As the fastener 168 is tightened, the second clamping bracket 64B draws and holds the boards 14 together.

To form the miter joint system 10, the boards 14 are cut to form the miter surfaces 30. Using a T-slot bit, equal length paths in the boards 14 are milled from the miter surfaces 30 to form the T-shaped slots 42A-C. The boards 14 are then subsequently milled using a standard pattern bit to form the kerfs 46A-D. The angled brackets 60A-C are inserted into the T-shaped slots 42A-C, and the fasteners 68A are inserted through the openings 82A-C of the angled brackets 60A-C. The boards 14 are pushed together over the angled brackets 60A-C such that the miter surfaces 30 are pressed against each other. The legs 90A-D, 94A-D of the clamping brackets 64A, 64B are positioned in the kerfs 46A-D and against the kerf surfaces 56A-D such that the boards 14 are drawn together. The nuts 72A-C are threaded on the fasteners 68A and tightened on the clamping brackets 64A, 64B to hold the miter joint system 10 together.

With reference to FIG. 1, when the miter joint system 10 is assembled, the second angled bracket and the third angled bracket 60C are arranged in the respective second and third T-shaped slots 42B, 42C of the boards 14. The second clamping bracket 64B is positioned against the kerf surfaces 56B-D. Specifically, the first legs 90B press against the kerf surfaces 56B-D of one of the boards 14 and the second legs 94B press against the kerf surfaces 56B-D of the other one of the boards 14. The second fastener and third fastener extend through the openings 82B of the angled bracket, the T-shaped slots 42B, 42C of the boards 14, and the through-holes 98B of the clamping bracket 64A. The second nut 72B and the third nut 72C are threaded and tightened on the second and third fasteners such that the second bracket subassembly 26 and the boards 14 are held together. As the second and third nuts 72B, 7C are tightened, the clamping bracket 64B draws and holds the boards 14 together. The second and third nuts 72B, 72C holds the second clamping bracket 64B against the kerf surfaces 56B.

Various features and advantages of the invention are set forth in the following claims.

What is claimed is:

1. A bracket assembly configured to join a first board and a second board, the bracket assembly comprising:
an angled bracket having a first segment configured to be inserted into the first board and a second segment forming a nonzero angle with the first segment and configured to be inserted into the second board;
a clamping bracket configured to press against a first kerf on the first board and a second kerf on the second board; and
a fastener coupled to the angled bracket and extending through the clamping bracket.

2. The bracket assembly of claim 1, wherein the angled bracket includes a boss, and wherein the boss defines a bore that receives a portion of the fastener to couple the fastener to the angled bracket.

3. The bracket assembly of claim 2, wherein the first segment intersects the second segment of the angled bracket at a corner, and wherein the boss extends from the corner toward the clamping bracket.

4. The bracket assembly of claim 3 wherein the angled bracket also includes a first fin extending between the boss and the first segment, and a second fin extending between the boss and the second segment.

5. The bracket assembly of claim 2, wherein the bore includes internal threads that threadably engage the fastener.

6. The bracket assembly of claim 1, wherein the clamping bracket is generally C-shaped and includes a center portion having a hole that receives the fastener, a first leg extending from the center portion and configured to press against the first kerf, and a second leg extending from the center portion opposite the first leg and configured to press against the second kerf.

7. The bracket assembly of claim 6, wherein the first leg is one of a plurality of first legs extending from the center portion, and wherein the second leg is one of a plurality of second legs extending from the center portion.

8. The bracket assembly of claim 1, further comprising a nut threaded on the fastener.

9. The bracket assembly of claim 1, wherein as the fastener is tightened, the clamping bracket presses against the first kerf and the second kerf to draw the first board and the second board together.

10. A furniture article comprising;
a first board having a first slot and a first kerf;
a second board having a second slot and a second kerf;
an angled bracket having a first segment and a second segment extending from the first segment, the first segment positioned in the first slot and the second segment positioned in the second slot;
a clamping bracket pressing against the first kerf and the second kerf such that the first board and the second board are drawn together; and
a fastener coupled to the angled bracket and extending through the clamping bracket.

11. The furniture article of claim 10, wherein the angled bracket includes a boss, and wherein the boss defines a bore that receives a portion of the fastener to couple the fastener to the angled bracket.

12. The furniture article of claim 11, wherein the first segment of the angled bracket intersects the second segment of the angled bracket at a corner, and wherein the boss extends from the corner toward the clamping bracket.

13. The furniture article of claim 10, wherein the clamping bracket is generally C-shaped and includes a center portion having a hole that receives the fastener, a first leg extending from the center portion to press against the first kerf, and a second leg extending from the center portion opposite the first leg to press against the second kerf.

14. The furniture article of claim 13, wherein the first leg of the clamping bracket is one of a plurality of first legs extending from the center portion, wherein the second leg of the clamping bracket is one of a plurality of second legs extending from the center portion, wherein each of the plurality of first legs presses against a kerf of the first board, and wherein each of the plurality of second legs presses against a kerf on the second board.

15. The furniture article of claim 10, wherein the first board and the second board includes a second miter surface, wherein the first slot extends from the first miter surface, and wherein the second slot extends from the second miter surface.

16. The furniture article of claim 10, wherein the first kerf is separate and spaced from the first slot.

17. The furniture article of claim 10, wherein the first kerf is connected to the first slot.

18. A method for assembling a furniture article including a first board and a second board, the method comprising:
inserting a first segment of an angled bracket into the first board;
inserting a second segment of the angled bracket into the second board, the second segment forming a nonzero angle with the first segment;
positioning a clamping bracket against a first kerf on the first board and a second kerf on the second board;
coupling a fastener to the angled bracket and the clamping bracket; and
tightening the fastener such that the clamping bracket presses against the first kerf and the second kerf to draw the first board and the second board together.

19. The method of claim 18, wherein the first board includes a first miter surface and a first slot extending from the first miter surface, wherein the second board includes a second miter surface and a second slot extending from the second miter surface, wherein inserting the first segment of the angled bracket into the first board includes inserting the first segment of the angled bracket into the first slot through the first miter surface, and wherein inserting the second segment of the angled bracket into the second board includes inserting the second segment of the angled bracket into the second slot through the second miter surface.

20. The method of claim 18, wherein coupling the fastener to the angled bracket and the clamping bracket includes inserting the fastener through the clamping bracket and into a boss of the angled bracket.
